(19) United States
(12) Patent Application Publication
(10) Pub. No.: US 2010/0279068 A1
(43) Pub. Date: Nov. 4, 2010

(54) EMBOSSED GLASS ARTICLES FOR ANTI-FINGERPRINTING APPLICATIONS AND METHODS OF MAKING

(76) Inventors: Glen Bennett Cook, Elmira, NY (US); Wageesha Senaratne, Horseheads, NY (US); Todd Parrish St. Clair, Painted Post, NY (US)

Correspondence Address: CORNING INCORPORATED, SP-TI-3-1, CORNING, NY, 14831, US

(21) Appl. No.: 12/624,978

(22) Filed: Nov. 24, 2009

Related U.S. Application Data
(60) Provisional application No. 61/175,101, filed on May 4, 2009.

(51) Int. Cl. B32B 3/00; B32B 17/06; C03B 23/02

(52) U.S. Cl. 428/141; 428/156; 428/172; 65/102

(57) ABSTRACT

A process for creating hydrophobic and oleophobic glass surfaces. The process consists of heating a glass article to temperatures near the glass softening point and pressing a textured mold into the glass article to create surface texture. The mold texture is selected to have dimensions that convey hydrophobicity and oleophobicity to the glass article when combined with appropriate surface chemistry. The surface features are controlled through choice of mold texture and through process parameters including applied pressure, temperature, and pressing time. Articles made by this process are also described.

### CROSS REFERENCE TO RELATED APPLICATIONS

This application claims the benefit of U.S. Provisional Patent Application No. 61/175,101, filed May 4, 2009.

### BACKGROUND

Surfaces for touch screen applications are increasingly in demand. From both aesthetic and technological standpoints, touch screen surfaces which are resistant to the transfer of fingerprints are desired. For applications related to hand-held electronic devices, the general requirements for the user-interactive surface include high transmission, low haze, resistance to fingerprint transfer, robustness to repeated use, and non-toxicity. A fingerprint-resistant surface must be resistant to both water and oil transfer when touched by a finger of a user. The wetting characteristics of such a surface are such that the surface is both hydrophobic and oleophobic.

The presence of roughness on the surface can alter the contact angle between a given fluid and flat substrate. One approach to creating surface roughness is deposition of a coating that comprises particles that convey the desired level of roughness. One disadvantage of this approach is that such particle-containing layers may not have sufficient durability and are wiped or rubbed of the surface during routine use. In some instances, this can be mitigated by the application of additional layers. Such steps however, significantly increase the cost and complexity of manufacturing fingerprint-resistant articles.

Another approach to providing roughness to a glass surface is to directly roughen or scratch the surface using hard polishing media. Here the roughness can be tuned through selection of the proper particle size of the polishing media. While durability is less of an issue using this approach, polishing compromises the cleanliness of the surface if the polishing media and debris are not completely removed, in which case additional manufacturing and cleaning steps are needed.

### SUMMARY

A process for creating hydrophobic and oleophobic glass surfaces is described. The process includes heating a glass article or substrate (unless otherwise specified, the terms “glass article” and “glass substrate” are equivalent terms and are used interchangeably herein) to temperatures where the glass has a viscosity in a range from about 10⁵ poise to 10⁸ poise and pressing a textured mold into the glass article to create texture on the surface of the glass article. The texture of the mold is selected to have dimensions that convey hydrophobicity and oleophobicity to the glass article when combined with appropriate surface chemistry provided by a coating of a fluoropolymer, fluorosilane, or both. The surface features and optical properties of the glass surface are controlled by selection of mold texture and process parameters including applied pressure, pressing temperature, and pressing time. Articles made by this process are also described.

Accordingly, one aspect of the disclosure is to provide a glass article having at least one embossed surface. The embossed surface has a texture and exhibits at least one of hydrophobic and oleophobic behavior.

A second aspect of the disclosure is to provide a glass substrate comprising an embossed surface. The embossed surface has a roughness that is sufficient to prevent a decrease in contact angle of droplets of water or oils on the embossed surface.

A third aspect of the disclosure is to provide a method of making a glass article having a surface that exhibits at least one of hydrophobic and oleophobic behavior. The method comprises providing the glass article and embossing at least one surface of the glass article to form at least one embossed surface. The embossed surface has a texture and exhibits at least one of hydrophobic and oleophobic behavior.

These and other aspects, advantages, and salient features will become apparent from the following detailed description, the accompanying drawings, and the appended claims.

### BRIEF DESCRIPTION OF THE DRAWINGS

FIG. 1a is a schematic representation of the Wenzel model of the wetting behavior of liquids on a roughened solid surface;

FIG. 1b is a schematic representation of the Cassie-Baxter model of the wetting behavior of liquids on a roughened solid surface;

FIG. 2a is a schematic representation of a process for embossing surfaces of a glass substrate;

FIG. 2b is a schematic representation of a second process for embossing surfaces of a glass substrate;

FIG. 3a is a scanning electron microscope (SEM) image (50× magnification) of a glass surface embossed using a glassy carbon template at a pressure of 6.7 psi;

FIG. 3b is a SEM image (50× magnification) of a glass surface embossed using a glassy carbon template at a pressure of 5.2 psi;

FIG. 3c is a SEM image (50× magnification) of a glass surface embossed using a glassy carbon template at a pressure of 2 psi;

FIG. 4 is optical image of an embossed glass surface prepared using porous graphite fiber paper as a template;

FIG. 5a is a microscopic image of a glass surface that was embossed using a stainless steel screen

FIG. 5b is a microscopic image of the glass surface of FIG. 5a that underwent a second embossing using a stainless steel screen; and

FIG. 6 is a microscopic image of an embossed glass surface prepared using a packed ZnO nanopowder on a graphite fiber paper mold.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range.

Referring to the drawings in general, it will be understood that the illustrations are for the purpose of describing particular embodiments and are not intended to limit the disclosure or appended claims thereto. The drawings are not necessarily to scale, and certain features and views of the drawings may be exaggerated in scale or in schematic in the interest of clarity and conciseness.

The primary characteristic of an article that repels fingerprints is that the surface must be non-wetting to fingerprints. As used herein, the terms “anti-fingerprint” and “anti-fingerprinting” refer to the resistance of a surface to the transfer of fluids and other materials found in human fingerprints; non-wetting properties of a surface; the minimization, hiding, or obscuring of human fingerprints on a surface, and combinations thereof. Fingerprints contain both sebaceous oils as well as aqueous components. Therefore, an anti-fingerprinting surface must be resistant to both water and oil transfer when touched. A description of such a surface, in terms of wetting characteristics, would be that the surface is hydrophobic (i.e., the contact angle (CA) between water and substrate is greater than 90°) and oleophobic (i.e., the contact angle between oil and substrate is greater than 90°).

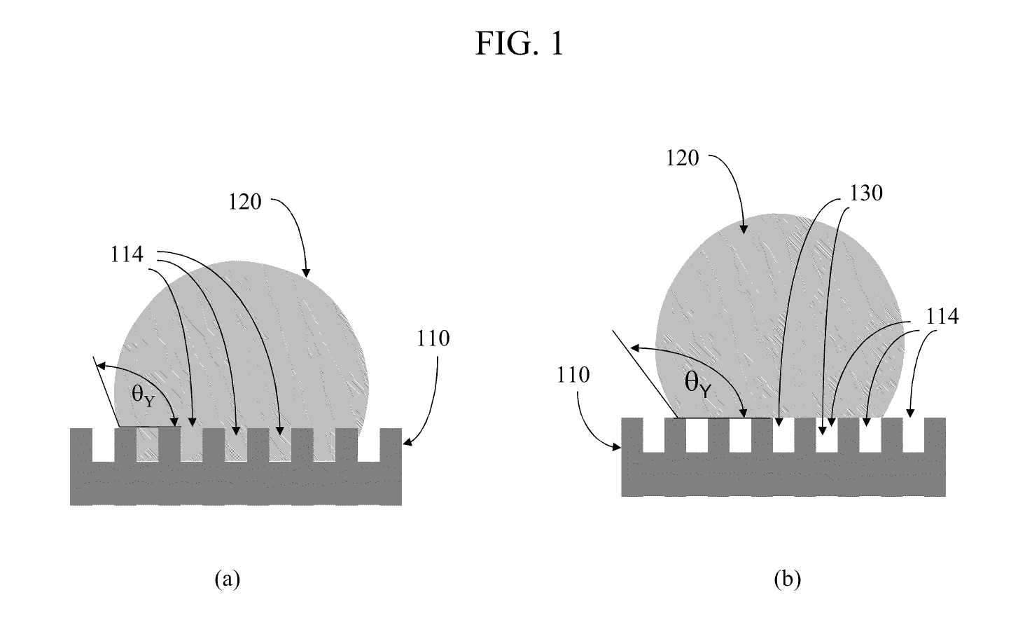

The presence of surface roughness (e.g., protrusions, depressions, grooves, pits, pores, voids, and the like) can alter the contact angle between a given fluid and a flat substrate. This effect of surface roughness on contact angle is also known as the “lotus” or “lotus leaf” effect. As described by Quéré (Ann Rev. Mater. Res. 2008, vol. 38, pp. 71-99), the wetting behavior of liquids on a roughened solid surface can be described by either the Wenzel (low contact angle) model or the Cassie-Baxter (high contact angle) model. In the Wenzel model, schematically shown in FIG. 1a, a fluid droplet 120 on a roughened solid surface 110 penetrates free space 114, which can include, but is not necessarily limited to, pits, holes, grooves, pores, voids and the like, on the roughened solid surface 110. The Wenzel model takes the increase in interface area of roughened solid surface 110 relative to a smooth surface (not shown) into account and predicts that when smooth surfaces are hydrophobic, roughening such surfaces will further increase their hydrophobicity. Conversely, when smooth surfaces are hydrophilic, the Wenzel model predicts that roughening such surfaces will further increase their hydrophilicity. In contrast to the Wenzel model, the Cassie-Baxter model (schematically shown in FIG. 1b) predicts that surface roughening always increases the contact angle θ_{Y} of fluid droplet 120 regardless of whether the smooth solid surface is hydrophilic or hydrophobic. The Cassie-Baxter model describes the case in which gas pockets 130 are formed in free space 114 of roughened solid surface 110 and trapped beneath fluid droplet 120 on a roughened solid surface 130, thus preventing a decrease in contact angle θ_{Y}. The presence of gas pockets 130 also increases contact angle θ_{Y} of fluid droplet 120. An anti-fingerprinting surface should, when in contact with a given fluid, maintain droplets in the Cassie-Baxter or high-contact angle state (FIG. 1b), in which gas pockets 130 are trapped beneath fluid droplets on a roughened solid surface 110 and, to some degree, prevent or retard a decrease in contact angle θ_{Y} and transition of fluid droplet 120 from the Cassie-Baxter state to the low contact angle Wenzel state (FIG. 1a).

The hydrophobicity and oleophobicity of surfaces are also related to the surface energy γ_{SV} of the solid substrate. The contact angle θ_{Y} of a surface with a fluid droplet is defined as

$$Cos {θ}_{Y} = \frac{{γ}_{SV} - {γ}_{SL}}{{γ}_{LV}}$$

where θ_{Y} is the contact angle for a flat surface (also known as Young's contact angle), γ_{SV} is the surface energy of the solid, γ_{SL} is the interface energy between the liquid and solid, and γ_{LV} is the liquid surface tension. In order for θ_{Y}>90°, the term cos θ_{Y} must be negative, thereby constraining the surface energy γ_{SV} to values less than γ_{SL}. The interface energy γ_{SL} between the liquid and solid is typically not known and the contact angle θ_{Y} is usually increased to greater than 90° (i.e., cos θ_{Y}<0) in order to minimize the surface energy γ_{SV} of the solid and achieve hydrophobicity and/or oleophobicity. For example, traditional smooth non-wetting surfaces, including fluorinated materials such as Teflon™ (polytetrafluoroethylene), have surface energies γ_{SV} as low as 18 dynes/cm. Such Teflon surfaces are not oleophobic, as oils such as oleic acid (γ_{LV} ˜32 dyne/cm) exhibit contact angles θ_{Y} of about 80° on Teflon and the surface is not oleophobic.

Anti-fingerprinting surfaces can be achieved by creating rough surfaces having low surface energy. Accordingly, a glass article or substrate (unless otherwise specified, the terms “glass article” and “glass substrate” are equivalent terms and are used interchangeably herein) having a roughened surface that is created through an embossing process is provided. The roughened embossed surface is hydrophobic and/or oleophobic and has anti-fingerprinting properties; i.e., the roughened surface repels or is resistant to fingerprinting. In particular embodiments, the embossed glass surfaces described herein are superamphiphobic—i.e., the contact angle of water and oleic acid with the surface is greater than 150°.

The embossing process includes heating a glass substrate to a temperature at which the viscosity of the glass is in a range from about 10⁵ poise to 10⁸ poise. This temperature is typically near the softening point (i.e., the temperature at which the viscosity of the glass is 10^{7.6} poise) of the glass. The softened glass surface is brought into contact with a textured or templated surface of a mold at some predetermined load to transfer an impression of the textured surface into the glass surface. The embossed surface of the glass is typically a continuous surface that is free of any undercutting or fracture surfaces. The transparency and haze levels of the glass can be tuned by varying the dimensions (e.g., laterally varying orientation and depth) of the surface features or the pressure exerted by the mold on the glass substrate during embossing.

The embossed surface provides an alternative to achieving rough surfaces through particle coatings and is more robust and durable than such coatings. Durability is conferred by the characteristic durability of the glass substrate and, as such, does not require any post-embossing treatments to increase durability. Furthermore, embossing eliminates the need for post-deposition processing such as, for example, polishing, that must be performed to increase the robustness of particle-based coatings. Multiple levels of roughness can be introduced in a minimal number of process steps. The embossing processes described herein are also scalable and adaptable to either batch (e.g., by hot pressing/embossing individual pieces) or continuous (e.g., by hot roller embossing) processing, and are therefore “manufacturing-friendly.”

In some embodiments, the roughened embossed surfaces described herein further include a coating deposited on the roughened embossed surfaces to enhance oleophobic behavior. The coating comprises at least one of a fluoropolymer or a fluorosilane. The combination of the roughened embossed surface and the fluoropolymer or fluorosilane coating exhibits the greatest degrees of hydrophobicity and oleophobicity. A fluoropolymer or fluorosilane coating alone is insufficient to provide the surface of a glass substrate with hydrophobic and/or oleophobic behavior. Teflon, for example, is not oleophobic, exhibiting contact angles θ_{Y} of about 80° for oils, including oleic acid, that are routinely studied and used in the art. Such fluoropolymers and fluorosilanes include, but are not limited to, Teflon and commercially available fluorosilanes such as Dow Corning 2604, 2624, and 2634; DK Optool DSX; Shintesu OPTRON™; heptadecafluoro silane (Gelest); FluoroSyl™ (Cytonix); and the like.

The process of embossing comprises contacting at least one surface of a glass substrate with a textured surface—or template—of a mold while simultaneously applying pressure to and heating the glass substrate. The textured surface can, in some embodiments, comprise either a regular or random array of features. In some embodiments, opposing surfaces of the glass substrate are contacted by separate textured surfaces. The surfaces of the glass substrate can be contacted by sandwiching the glass substrate between two textured surfaces or, optionally, between one textured surface and one smooth surface. In another embodiment, the at least one textured surface is disposed on a surface of a roller that contacts the surface of the glass substrate. The glass substrate is heated to a temperature at which the viscosity of the glass is in a range from about 10⁵ poise to 10⁸ poise so that the at least one glass surface is deformed or molded into the features of the template.

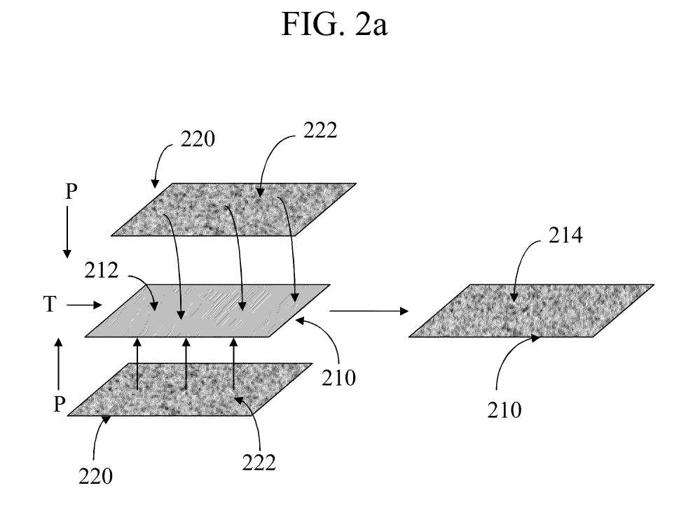

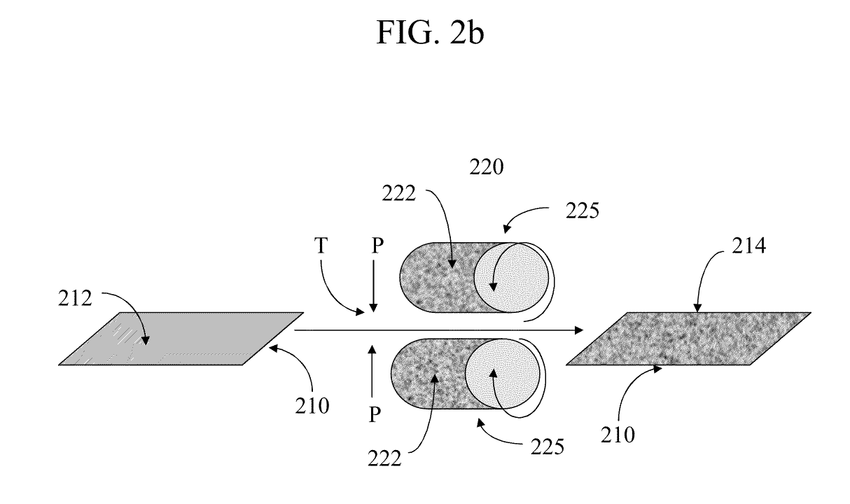

One embodiment of the embossing process is schematically shown in FIG. 2a. A glass substrate 210 having two smooth surfaces 212 is sandwiched between two halves of a mold 220, each half of mold 220 having a textured surface 222. Glass substrate 210 is heated to a temperature T at which the viscosity of glass substrate 210 is in a range from about 10⁵ poise to 10⁸ poise. Pressure P is applied to mold 220 and heated glass substrate 210. Textured surfaces 222 of mold 220 are pressed into smooth surfaces 212 of the heated glass substrate 210 to emboss and transfer features of textured surfaces 222 to smooth surfaces 210 and create textured surfaces 214 on glass substrate 210.

A second embodiment of the embossing process is schematically shown in FIG. 2b. In this instance, mold 220 comprises two opposing rollers 225. Each roller 225, in one embodiment, has a textured surface 222. Glass substrate 210 having two smooth surfaces 212 is sandwiched between rollers 225. Glass substrate 210 is heated to a temperature T at which the viscosity of glass substrate 210 is in a range from about 10⁵ poise to 10⁸ poise, and pressure P is applied to rollers 225 as textured surfaces 222 of rollers 225 are pressed into smooth surfaces 212 of the heated glass substrate 210 to emboss and transfer features of textured surfaces 222 to smooth surfaces 210, thus creating textured surfaces 214 on glass substrate 210.

FIGS. 2a and 2b show embodiments in which both smooth surfaces 212 of glass substrate 210 are embossed. In other embodiments, a single side of the glass substrate 210 is embossed. The surface of the glass substrate opposite the surface that is embossed has a second structure or texture that is transferred from the other (i.e., not textured) side of the mold. This second texture is frequently removed by polishing.

Mold 220 comprises a material or materials that are chemically inert with respect to glass substrate 210 and any materials that are used to form textured surfaces 222 and stable at the temperatures at which glass substrate 210 is embossed. In addition, the materials comprising mold 220 have high hardness and are capable of being readily textured by those means and methods known in the art, such as etching, milling, polishing, lapping, sandblasting, and the like. Suitable mold materials include, but are not limited to, glassy carbon, silicon nitride, silica (SiO₂), silicon (Si), graphite, nickel-based alloys such as Inconel™ or the like, stainless steels, and combinations thereof. In one non-limiting example, a silicon nitride-coated SiO₂ layer on a Si substrate can be used to emboss submicron features on the order of a few hundred nanometers in the surface of a glass substrate.

In one embodiment, mold 220 comprises glassy carbon. Glassy carbon can tolerate high temperatures (up to 2000° C. in an inert (N₂) atmosphere), is chemically stable, has high hardness, is gas impermeable, and separates readily from glass surfaces after hot embossing. Glassy carbon surfaces can be textured using techniques known in the art, such as focused ion beam milling.

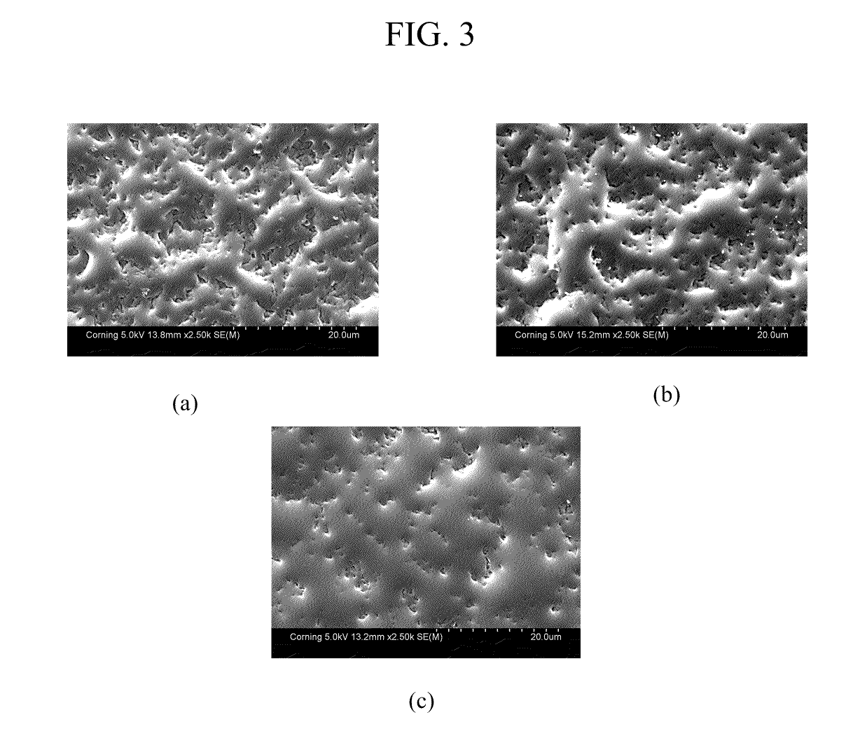

The effects of the pressure used to emboss the surface of the glass substrate on surface topography are shown in FIGS. 3a-c. Scanning electron microscope (SEM) images (50× magnification) of glass surfaces embossed using glassy carbon templates at pressures of 6.7 psi (FIG. 3a), 5.2 psi (FIGS. 3b), and 2 psi (FIG. 3c) are shown. As can be seen from the figures, greater degrees of texture are obtained when greater pressures are applied during embossing. RMS roughnesses of glass surfaces embossed using glassy carbon templates are listed as a function of applied pressure in Table 1. The roughness of the embossed surfaces also increases as greater pressure is applied during the embossing process.

The amount of pressure applied to the glass surface during the embossing process also affects the optical properties of the embossed glass surface and substrate. In addition to RMS roughness, Table 1 lists the haze and transmission of glass samples embossed at different applied pressures using glassy carbon templates. As can be seen from Table 1, haze increases with increased pressure, whereas transmission remains relatively unchanged, ranging from 91.9% to 93.4%.

In addition to anti-fingerprinting properties, the embossed surfaces described herein also have anti-glare properties, which are characterized in terms of gloss. As with haze, transmission, and roughness, gloss is affected by the amount of pressure applied during the embossing process. Table 1 also lists gloss measurements for glass samples embossed at different applied pressures using glassy carbon templates. As used herein, the term “gloss” refers to the measurement of specular reflectance calibrated to a standard (such as, for example, a certified black glass standard) in accordance with ASTM procedure D523. Gloss measurements are typically performed at incident light angles of 20°, 60°, and 85°, with the most commonly used gloss measurement being performed at 60°. The results, listed in Table 1, show that gloss generally decreases as embossing pressure increases to 1.76 psi and then increases as greater pressure (2.57 psi) is applied.

TABLE 1
Optical properties of glass surfaces embossed using glassy
carbon templates.

| | | | | RMS | | | |
|---|---|---|---|---|---|---|---|
| | Pressure | % | % | roughness | % Gloss | | |
| Sample | (psi) | Haze | Transmission | (nm) | 20° | 60° | 85° |
| 1 | 0.22 | 3.87 | 93 | 231 ± 20 | | | |
| 2 | 0.48 | 13.5 | 92.8 | 336 ± 18 | 4.1 | 26.7 | 71.4 |
| 3 | 0.73 | 31.5 | 93.4 | 560 ± 33 | 1.6 | 12.9 | 49.4 |
| 4 | 1.76 | 52.5 | 92.8 | 686 ± 112 | 0.5 | 6.5 | 33.8 |
| 5 | 2.57 | 53.2 | 91.9 | | 0.5 | 10.3 | 41.9 |

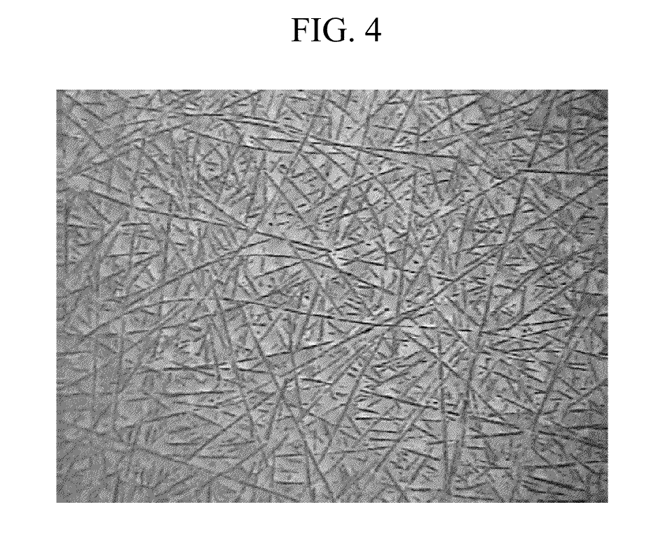

A microscopic image of a typical embossed surface that is produced using porous graphite fiber paper is shown in FIG. 4. A glass slide was brought into contact with the graphite fiber paper and heated to a temperature at which the viscosity of the glass was in a range from about 10⁵ poise to 10⁸ poise and pressure was applied so that the topography of the textured surface of the graphite paper was transferred. The image shown in FIG. 4 illustrates the fibrous-like surface features of the embossed surface of the glass substrate that resulted from the graphite-fiber based template. The embossed surface has an RMS roughness value on the order of about 5 μm, as determined by interferometry. The article is transparent when backlit. After coating with a fluorosilane (Dow Corning 2604), the embossed glass surface shown in FIG. 4 exhibited hydrophobic and slightly oleophobic behavior, with contact angles θ_{Y} of about 106° for water and about 91° for oleic acid. In comparison, the contact angle for oleic acid for Dow Corning 2604-coated surfaces that are not embossed is typically about 75°. Thus, the texture provided by embossing improved the oleophobicity of the glass substrate.

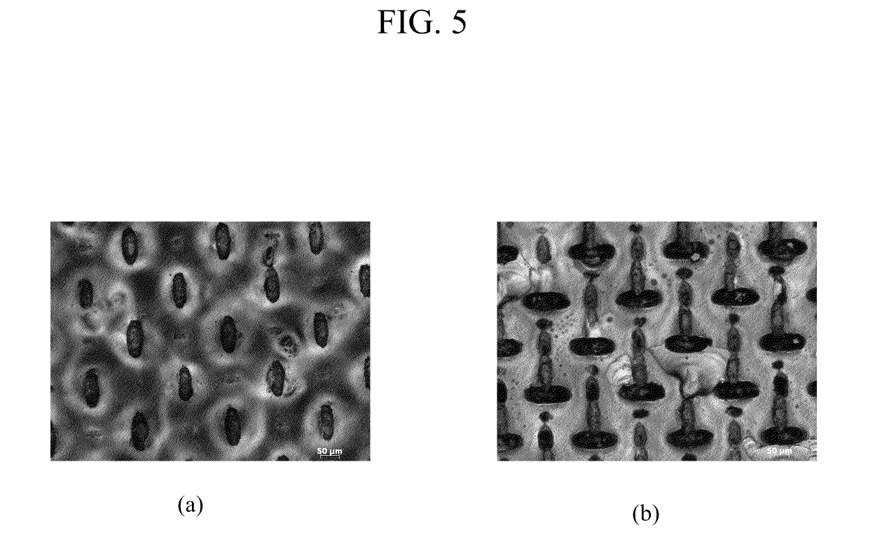

Optical images of two embossed surfaces are shown in FIGS. 5a-b. A stainless steel mesh was used as the embossing template to produce the embossed glass surface shown in both images. FIG. 5a shows a glass surface that was heated at 850° C. and embossed with the stainless steel screen. The screen was held in contact with the glass surface for 1 minute under a pressure of 0.54 psi. In addition to a first embossing similar to that shown in FIG. 5a, the embossed glass surface shown in FIG. 5b underwent a second embossing with a stainless steel screen. For the second embossing, the screen was rotated 90° from the orientation used in the first embossing. In the second embossing, the glass surface was heated to 840° C. and the screen was held in contact with the glass surface under a pressure of 0.73 psi. The first embossing resulted in an increase in the water contact angle of the glass surface to about 114° and an oleic acid contact angle of about 80°. The second embossing further enhanced the wettability of the glass surfaces, as the change in surface texture produced by the second embossing was sufficient to provide the embossed glass surface with moderate (water contact angle of about 124°) hydrophobicity and weak (oleic acid contact angle of about 90°) oleophobicity.

Dimensions of the surface features and roughness play a role in the wettability and optical properties of the embossed article. The data listed in Table 2 illustrate the effect of RMS roughness and surface texture on contact angle, transmission, and haze. Results are shown for a glass surface having a random texture formed by embossing the surface with porous graphite fiber paper (FIG. 4), a glass surface having a periodic texture formed by embossing the surface stainless steel mesh (FIG. 5a), and a glass surface formed by embossing the surface with a polished and lapped glassy carbon mold. The embossed surfaces of all samples listed in Table 2 were coated with Dow Corning 2604-coated fluorosilane. The data listed in Table 2 show that the type of surface texture embossed on the glass can be selected to achieve a desired level of oleophobicity and haze. In some embodiments, the glass substrate has a haze of less than about 10% whereas, in other embodiments, the haze is in a range from about 10% up to about 50%.

TABLE 2
Properties of embossed surfaces.

| | Average contact | | RMS | | |
|---|---|---|---|---|---|
| Surface | angle (degrees) | | roughness | | |
| texture | Water | Oil | (μm) | % Transmission | % Haze |
| Random | 110 | 92 | 3-5 | 93-94 | 25-30 |
| Periodic | 124 | 90 | — | 87 | 46 |
| Polished | 117 | 81 | 0.3-0.8 | 92-94 | 6-40 |
| & lapped | | | | | |

In other embodiments, embossing the glass surface includes embedding refractory materials into the glass surface. The refractory materials are applied to the mold surface or substrate surface prior to embossing, and are in the form of particles ranging in size from about 0.001 μm up to about 1000 μm. Such refractory materials include inorganic or metal oxides such as, but not limited to, zinc oxide, tin oxide (SnO₂), alumina, ceria, titania, silica, and combinations thereof. Contacting the refractory material particles with a glass surface at high temperature and pressure results in enhanced bonding between the particles and glass surface and increased durability. Because these particles are pressed into the surface of the glass, the surface structure is different than those instances in which the particles are applied as a separate coating on top of the glass surface. In one embodiment, the refractory materials are nanoparticles and are provided in either in powder form or as a colloidal dispersion or slurry. Application of the nanoparticles to the mold surface can be achieved using a packed powder or, if present as a colloidal dispersion or slurry, through spray-coating, dip-coating, spin-coating, aerosol deposition, or the like. Application of the nanoparticles as a colloidal suspension or slurry generally provides more uniform coverage of surface than application of the nanoparticles as a packed powder.

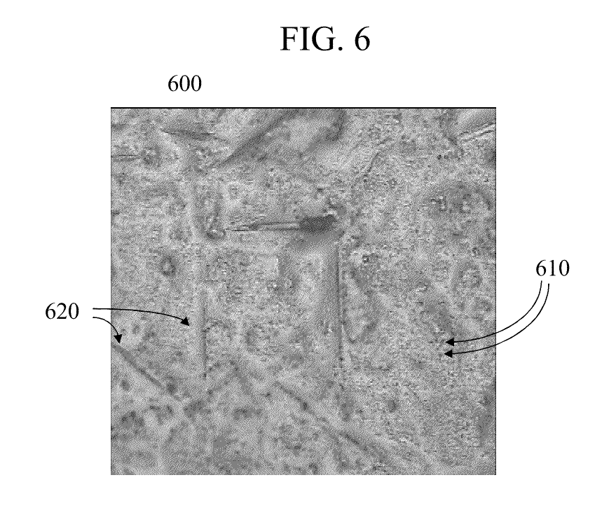

An optical image of an embossed glass substrate surface comprising embedded ZnO nanoparticles is shown in FIG. 6. The embossed surface 600 was prepared using a packed ZnO nanopowder on a graphite fiber paper mold. The nano-powder (40-100 nm) was embedded into the glass substrate by heating the glass surface at 875° C. and holding the graphite paper and ZnO nanoparticles in contact with the glass surface under a pressure of 0.73 psi. As a result of pressing the ZnO nanoparticles with the graphite fiber paper, the embossed surface 600 has two discrete textures or sets of topographical features: a first texture attributable to the embedded ZnO particles 610 and a second texture comprising fiber features 620 that were transferred from the graphite paper. The RMS roughness value of embossed surface 600 is about 2 μm, as measured by interferometry.

In some embodiments, additional surface structuring, such as negative structures (e.g., depressions, pores, and the like) can be formed by preferentially etching either the embedded refractory material or the glass substrate.

In other embodiments, the lotus leaf effect and anti-fingerprinting properties can be achieved by providing the surface of the glass substrate with hierarchal roughness; i.e., roughnesses in different size domains or multiple levels of surface roughness. Such hierarchal roughness can, in some embodiments, comprise a first plurality of topographical features having an average dimension that is within a first size range and a second plurality of topographical features having an average dimension that is within a second size range, wherein the average dimension and size ranges of each of the pluralities of topographical features differ from those of the other plurality (or pluralities) of topographical feature(s). The embossing methods described herein can provide such multiple levels of surface roughness through the use of a mold or molds having hierarchal textures. In one embodiment, a single mold may comprise such hierarchal textures or topographical features. In another embodiment, a glass surface having hierarchal texture or roughness can be achieved by embedding nanoparticles and using a mold having a different texture, as seen in FIG. 6 and described above. In another embodiment, hierarchal texture is provided through multiple embossing steps, such as those shown in FIGS. 5a and 5b, in which molds having different topological features or textures are used to emboss the surface of the glass substrate.

Table 2 shows the effect of multiple levels of surface roughness and hierarchal or multiple levels of texture on water and oil contact angles and optical properties. ZnO particles were deposited on the surfaces of a first set of glass substrates by dip coating the substrates in an aqueous slurry comprising 50 wt % ZnO at different dip withdrawal speeds. The deposited ZnO particles were then embedded in the glass surface using the methods described herein. Ceria (CeO₂) particles were deposited on the surfaces of a second set of glass substrates by dip coating the substrate in an aqueous slurry comprising 18 wt % CeO₂ at different dip withdrawal speeds. The deposited ceria particles were then embedded in the glass surface using the methods described herein. Either ZnO or CeO₂ particles were embedded in the surfaces of a third set of glass substrates and then removed by etching to create negative features in the embossed glass surface. All samples were coated with a fluorosilane after coating or embossing and etching. As can be seen from the data listed in Table 2, superhydrophobicity (contact angle θ_{Y} of water droplet with the surface ≧150°) and oleophobicity can be achieved using multiple levels of texture. Haze and transmission of the embossed glass can be adjusted through selection or choice of powders, solution concentration, coating thickness, etching parameters, and the like.

TABLE 2
Effects of multiple levels of texture on contact angle
and optical properties of embossed glass substrates.

| | Average contact angle | | | |
|---|---|---|---|---|
| | (degrees) | | Transmission | Haze |
| Sample | Water | Oil | (%) | (%) |
| Embedded with 50 | | | | |
| wt % ZnO slurry | | | | |
| ZnO (coating | 150 | 120 | 69 | 84 |
| speed 5 mm/min) | | | | |
| ZnO (coating | 147 | 126 | 69 | 85 |
| speed 10 mm/min) | | | | |
| Embedded with 50 | | | | |
| wt % CeO₂ slurry | | | | |
| CeO₂ (coating | 146 | 113 | 83 | 19 |
| speed 25 mm/min) | | | | |
| CeO₂ (coating | 146 | 118 | 83 | 20 |
| speed 10 mm/min) | | | | |
| Embedded and | | | | |
| etched | | | | |
| ZnO | 134 | 95 | 93 | 13 |
| CeO₂ | 143 | 115 | 93 | 16 |

The embossing processes described herein can be used to emboss glass substrates in either batch or continuous processes. In a non-limiting example of a batch process, each glass substrate is embossed separately (FIG. 2a). A continuous process can employ hot roller-based embossing methods in which heated rollers having the desired texture and, optionally, materials to be embedded are contacted with the surfaces of the glass substrate that are to be embossed to produce the embossed glass surfaces (FIG. 2b).

In one embodiment, the glass article comprises, consists essentially of, or consists of a soda lime glass. In another embodiment, the glass article comprises, consists essentially of, or consists of any glass that can be down-drawn, such as, but not limited to, an alkali aluminosilicate glass. In one embodiment, the alkali aluminosilicate glass comprises, consists essentially of, or consists of: 60-72 mol % SiO₂; 9-16 mol % Al₂O₃; 5-12 mol % B₂O₃; 8-16 mol % Na₂O; and 0-4 mol % K₂O, wherein the ratio

$$\frac{{Al}_{2} {O}_{3} ( mol \% ) + {B}_{2} {O}_{3} ( mol \% )}{\sum alkali metal modifiers ( mol \% )} > 1 ,$$

where the alkali metal modifiers are alkali metal oxides. In another embodiment, the alkali aluminosilicate glass comprises, consists essentially of, or consists of: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO. In yet another embodiment, the alkali aluminosilicate glass comprises, consists essentially of, or consists of: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %. In another embodiment, the alkali aluminosilicate glass comprises, consists essentially of, or consists of: 64-68 mol % SiO₂; 12-16 mol % Na₂O; 8-12 mol % Al₂O₃; 0-3 mol % B₂O₃; 2-5 mol % K₂O; 4-6 mol % MgO; and 0-5 mol % CaO, wherein: 66 mol %≦SiO₂+B₂O₃+CaO≦69 mol %; Na₂O+K₂O+B₂O₃+MgO+CaO+SrO>10 mol %; 5 mol %≦MgO+CaO+SrO≦8 mol %; (Na₂O+B₂O₃)—Al₂O₃≦2 mol %; 2 mol %≦Na₂O—Al₂O₃≦6 mol %; and 4 mol %≦(Na₂O+K₂O)—Al₂O₃≦10 mol %. In another embodiment, the alkali aluminosilicate glass comprises, consists essentially of, or consists of: 50-80 wt % SiO₂; 2-20 wt % Al₂O₃; 0-15 wt % B₂O₃; 1-20 wt % Na₂O; 0-10 wt % Li₂O; 0-10 wt % K₂O; and 0-5 wt % (MgO+CaO+SrO+BaO); 0-3 wt % (SrO+BaO); and 0-5 wt % (ZrO₂+TiO₂), wherein 0≦(Li₂O+K₂O)/Na₂≦0.5.

In one particular embodiment, the alkali aluminosilicate glass has the composition: 66.7 mol % SiO₂; 10.5 mol % Al₂O₃; 0.64 mol % B₂O₃; 13.8 mol % Na₂O; 2.06 mol % K₂O; 5.50 mol % MgO; 0.46 mol % CaO; 0.01 mol % ZrO₂; 0.34 mol % As₂O₃; and 0.007 mol % Fe₂O₃. In another particular embodiment, the alkali aluminosilicate glass has the composition: 66.4 mol % SiO₂; 10.3 mol % Al₂O₃; 0.60 mol % B₂O₃; 4.0 mol % Na₂O; 2.10 mol % K₂O; 5.76 mol % MgO; 0.58 mol % CaO; 0.01 mol % ZrO₂; 0.21 mol % SnO₂; and 0.007 mol % Fe₂O₃.

The alkali aluminosilicate glass is, in some embodiments, substantially free of lithium, whereas in other embodiments, the alkali aluminosilicate glass is substantially free of at least one of arsenic, antimony, and barium. In some embodiments, the glass article is down-drawn, using those methods known in the art such as, but not limited to fusion-drawing, slot-drawing, re-drawing, and the like, and has a liquid viscosity of at least 135 kpoise.

Non-limiting examples of such alkali aluminosilicate glasses are described in U.S. patent application Ser. No. 11/888,213, by Adam J. Ellison et al., entitled “Down-Drawable, Chemically Strengthened Glass for Cover Plate,” filed on Jul. 31, 2007, which claims priority from U.S. Provisional Patent Application 60/930,808, filed on May 22, 2007, and having the same title; U.S. patent application Ser. No. 12/277,573, by Matthew J. Dejneka et al., entitled “Glasses Having Improved Toughness and Scratch Resistance,” filed on Nov. 25, 2008, which claims priority from U.S. Provisional Patent Application 61/004,677, filed on Nov. 29, 2007, and having the same title; U.S. patent application Ser. No. 12/392,577, by Matthew J. Dejneka et al., entitled “Fining Agents for Silicate Glasses,” filed Feb. 25, 2009, which claims priority from U.S. Provisional Patent Application No. 61/067,130, filed Feb. 26, 2008, and having the same title; U.S. patent application Ser. No. 12/393,241 by Matthew J. Dejneka et al., entitled “Ion-Exchanged, Fast Cooled Glasses,” filed Feb. 25, 2009, which claims priority from U.S. Provisional Patent Application No. 61/067,732, filed Feb. 29, 2008, and having the same title; U.S. patent application Ser. No. 12/537,393, by Kristen L. Barefoot et al., entitled “Strengthened Glass Articles and Methods of Making,” filed Aug. 7, 2009, which claims priority from U.S. Provisional Patent Application No. 61/087,324, entitled “Chemically Tempered Cover Glass,” filed Aug. 8, 2008; U.S. Provisional Patent Application No. 61/235,767, by Kristen L. Barefoot et al., entitled “Crack and Scratch Resistant Glass and Enclosures Made Therefrom,” filed Aug. 21, 2009; and U.S. Provisional Patent Application No. 61/235,762, by Matthew J. Dejneka et al., entitled “Zircon Compatible Glasses for Down Draw,” filed Aug. 21, 2009; the contents of which are incorporated herein by reference in their entirety.

In one embodiment, the glass article is thermally or chemically strengthened after embossing, and either before or after being cut or otherwise separated from a “mother sheet” of glass. The strengthened glass article has strengthened surface layers extending from a first surface and a second surface to a depth of layer below each surface. The strengthened surface layers are under compressive stress, whereas a central region of the glass article is under tension, or tensile stress, so as to balance forces within the glass. In thermal strengthening (also referred to herein as “thermal tempering”), the glass article is heated up to a temperature that is greater than the strain point of the glass but below the softening point of the glass and rapidly cooled to a temperature below the strain point to create strengthened layers at the surfaces of the glass article. In another embodiment, the glass article can be strengthened chemically by a process known as ion exchange. In this process, ions in the surface layer of the glass are replaced by—or exchanged with—larger ions having the same valence or oxidation state. In those embodiments in which the glass article comprises, consists essentially of, or consists of an alkali aluminosilicate glass, ions in the surface layer of the glass and the larger ions are monovalent alkali metal cations, such as Li⁺ (when present in the glass), Na⁺, K⁺, Rb⁺, and Cs⁺. Alternatively, monovalent cations in the surface layer may be replaced with monovalent cations other than alkali metal cations, such as Ag⁺ or the like.

Ion exchange processes typically comprise immersing a glass article in a molten salt bath containing the larger ions to be exchanged with the smaller ions in the glass. It will be appreciated by those skilled in the art that parameters for the ion exchange process including, but not limited to, bath composition and temperature, immersion time, the number of immersions of the glass in a salt bath (or baths), use of multiple salt baths, additional steps such as annealing, washing, and the like, are generally determined by the composition of the glass and the desired depth of layer and compressive stress of the glass to be achieved by the strengthening operation. By way of example, ion exchange of alkali metal-containing glasses may be achieved by immersion in at least one molten salt bath containing a salt such as, but not limited to, nitrates, sulfates, and chlorides of the larger alkali metal ion. The temperature of the molten salt bath typically is in a range from about 380° C. up to about 450° C., while immersion times range from about 15 minutes up to about 16 hours. However, temperatures and immersion times different from those described above may also be used. Such ion exchange treatments typically result in strengthened alkali aluminosilicate glasses having depths of layer ranging from about 10 μm up to at least 50 μm with a compressive stress ranging from about 200 MPa up to about 800 MPa, and a central tension of less than about 100 MPa.

Non-limiting examples of ion exchange processes are provided in the U.S. patent applications and provisional patent applications that have been previously referenced hereinabove. Additional non-limiting examples of ion exchange processes in which glass is immersed in multiple ion exchange baths, with washing and/or annealing steps between immersions, are described in U.S. patent application Ser. No. 12/500,650, by Douglas C. Allan et al., entitled “Glass with Compressive Surface for Consumer Applications,” filed Jul. 10, 2009, which claims priority from U.S. Provisional Patent Application No. 61/079,995, filed Jul. 11, 2008, and having the same title, in which glass is strengthened by immersion in multiple, successive, ion exchange treatments in salt baths of different concentrations; and U.S. patent application Ser. No. 12/510,599, by Christopher M. Lee et al., entitled “Dual Stage Ion Exchange for Chemical Strengthening of Glass,” filed Jul. 28, 2009, which claims priority from U.S. Provisional Patent Application No. 61/084,398, filed Jul. 29, 2008, and having the same title, in which glass is strengthened by ion exchange in a first bath is diluted with an effluent ion, followed by immersion in a second bath having a smaller effluent ion concentration than the first bath. The contents of U.S. Provisional patent application Ser. Nos. 12/500,650 and 12/510,599 are incorporated herein by reference in their entirety.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A glass article, the glass article comprising at least one embossed surface, the embossed surface having a texture and exhibiting at least one of hydrophobic and oleophobic behavior.

2. The glass article of claim 1, wherein the glass article further comprises a coating disposed on the embossed surface, the coating comprising at least one of a fluoropolymer and a fluorosilane.

3. The glass article of claim 2, wherein the embossed surface coated with the coating has a water contact angle that is greater than or equal to about 110°.

4. The glass article of claim 2, wherein the embossed surface coated with the coating has an oil contact angle that is greater than about 90°.

5. The glass article of claim 1, wherein the embossed surface further comprises a refractory material other than glass embedded in the embossed surface.

6. The glass article of claim 5, wherein the refractory material comprises nanoparticles of at least one metal oxide.

7. The glass article of claim 6, wherein the at least one metal oxide is selected from the group consisting of zinc oxide, tin oxide, alumina, ceria, titania, silica, and combinations thereof.

8. The glass article of claim 1, wherein the embossed surface comprises a negative structure.

9. The glass article of claim 1 wherein the embossed surface has multiple levels of surface roughness.

10. The glass article of claim 1, wherein the glass article is an alkali aluminosilicate glass.

11. The glass article of claim 10, wherein the alkali aluminosilicate glass comprises: 60-72 mol % SiO₂; 9-16 mol % Al₂O₃; 5-12 mol % B₂O₃; 8-16 mol % Na₂O; and 0-4 mol % K₂O, wherein the ratio
$$\frac{{Al}_{2} {O}_{3} ( mol \% ) + {B}_{2} {O}_{3} ( mol \% )}{\sum alkali metal modifiers ( mol \% )} > 1 ,$$
where the alkali metal modifiers are alkali metal oxides.

12. The glass article according to claim 10, wherein the alkali aluminosilicate glass comprises: 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO.

13. The glass article according to claim 10, wherein the alkali aluminosilicate glass comprises: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol %≦Li₂O+Na₂O+K₂O≦20 mol % and 0 mol %≦MgO+CaO≦10 mol %.

14. The glass article of claim 10, wherein the glass is thermally or chemically strengthened.

15. The glass article of claim 14, wherein the glass is chemically strengthened by ion exchange.

16. The glass article of claim 1, wherein the glass article has a haze of less than about 10%.

17. The glass article of claim 1, wherein the glass article has a haze in a range from about 10% up to about 50%.

18. The glass article of claim 1, wherein the glass article is one of a touch screen, a protective cover glass for a hand-held electronic device, an information-related terminal, and a touch sensor device.

19. A glass substrate, the glass substrate comprising an embossed surface having a roughness that is sufficient to prevent a decrease in contact angle of droplets of water or oils on the embossed surface.

20. A method of making a glass article having a surface that exhibits at least one of hydrophobic and oleophobic behavior, the method comprising the steps of:
a. providing the glass article; and
b. embossing at least one surface of the glass article to form at least one embossed surface, wherein the embossed surface has a texture and exhibits at least one of hydrophobic and oleophobic behavior.

21. The method of claim 20, wherein the step of embossing the at least one surface comprises:
a. contacting the at least one surface with a textured surface of a mold;
b. heating the glass article to a temperature at which the glass article has a viscosity in a range from about 10⁵ poise to 10⁸ poise while the glass article contacts the textured surface; and
c. applying pressure to the at least one surface and the textured surface to form the at least one embossed surface.

22. The method of claim 20, wherein the step of embossing at least one surface comprises:
a. contacting the at least one surface with a plurality of particles of at least one refractory material;
b. heating the glass article to a temperature at which the glass article has a viscosity in a range from about 10⁵ poise to 10⁸ poise while the glass article contacts the refractory material; and
c. pressing the plurality of particles into the at least one surface to form the embossed surface.

23. The method of claim 20, further comprising depositing a coating comprising at least one of a fluoropolymer and a fluorosilane on the at least one embossed surface, wherein the coating enhances at least one of hydrophobic and oleophobic behavior of the embossed surface.

24. The method of claim 20, further comprising the step of etching the embossed surface to form negative features in the embossed surface.

25. The method of claim 20, wherein the textured surface of the mold comprises at least one of glassy carbon, graphite, silicon nitride, silica, silicon, and a nickel-based alloy.
